(19) United States
(12) Patent Application Publication
(10) Pub. No.: US 2006/0254356 A1
(43) Pub. Date: Nov. 16, 2006

(54) Wireless and passive acoustic wave liquid conductivity sensor

(75) Inventors: James ZT Liu, Belvidere, IL (US); Michael L. Rhodes, Richfield, MN (US); Aziz Rahman, Sharon, MA (US)

Correspondence Address: Honeywell International, Inc.;Attorney, Intellectual Property, 101 Columbia Rd., P.O. Box 2245, Morristown, NJ, 07962, US

(73) Assignee: Honeywell International, Inc.

(21) Appl. No.: 11/127,635

(22) Filed: May 11, 2005

(51) Int. Cl. G01N 29/02

(52) U.S. Cl. 73/592

(57) ABSTRACT

A method and system for measuring liquid conductivity utilizing an acoustic wave sensor. In general, an acoustic wave device can be provided with one or more interdigital transducers, including at least a first interdigital transducer and at least a second interdigital transducer having a cavity formed therebetween, wherein liquid comes into contact with the cavity. For example, a liquid, such as oil, may flow through the cavity. A measurement of the resistance and/or frequency of the acoustic wave device next to the cavity can be performed in order to obtain data indicative of the conductivity of the liquid.

### TECHNICAL FIELD

Embodiments are generally related to sensing devices and components thereof. Embodiments are also related to liquid conductivity sensors. Embodiments additionally relate to acoustic wave devices. Embodiments also relate to the wireless transmission of sensed data.

### BACKGROUND OF THE INVENTION

Acoustic wave sensors are utilized in a variety of sensing applications, such as, for example, temperature and/or pressure sensing devices and systems. Acoustic wave devices have been in commercial use for over sixty years. Although the telecommunications industry is the largest user of acoustic wave devices, they are also used for chemical vapor detection. Acoustic wave sensors are so named because they use a mechanical or acoustic wave as the sensing mechanism. As the acoustic wave propagates through or on the surface of the material, any changes to the propagation path affect the characteristics of the wave.

Changes in acoustic wave characteristics can be monitored by measuring the frequency or phase characteristics of the sensor and can then be correlated to the corresponding physical quantity or chemical quantity that is being measured. Virtually all acoustic wave devices and sensors utilize a piezoelectric crystal to generate the acoustic wave. Three mechanisms can contribute to acoustic wave sensor response, i.e., mass-loading, visco-elastic and acousto-electric effect. The mass-loading of chemicals alters the frequency, amplitude, and phase and Q value of such sensors. Most acoustic wave chemical detection sensors, for example, rely on the mass sensitivity of the sensor in conjunction with a chemically selective coating that absorbs the vapors of interest resulting in an increased mass loading of the acoustic wave sensor.

Examples of acoustic wave sensors include acoustic wave detection devices, which are utilized to detect the presence of substances, such as chemicals, or environmental conditions such as temperature and pressure. An acoustical or acoustic wave (e.g., SAW/BAW) device acting as a sensor can provide a highly sensitive detection mechanism due to the high sensitivity to surface loading and the low noise, which results from their intrinsic high Q factor. Surface acoustic wave devices are typically fabricated using photolithographic techniques with comb-like interdigital transducers placed on a piezoelectric material. Surface acoustic wave devices may have either a delay line or a resonator configuration. Bulk acoustic wave devices are typically fabricated using a vacuum plater, such as those made by CHA, Transat or Saunder. The choice of the electrode materials and the thickness of the electrode are controlled by filament temperature and total heating time. The size and shape of electrodes are defined by proper use of masks.

Surface acoustic wave resonator (SAW-R), surface acoustic wave delay line (SAW-DL), surface transverse wave (STW), bulk acoustic wave (BAW), and acoustic plate mode (APM) all can be utilized in various sensing measurement applications. One of the primary differences between an acoustic wave sensor and a conventional sensor is that an acoustic wave sensor can store energy mechanically. Once such a sensor is supplied with a certain amount of energy (e.g., through RF), the sensor can operate for a time without any active part (e.g., without a power supply or oscillator). This feature makes it possible to implement an acoustic wave sensor in an RF powered passive and wireless sensing application.

One area where acoustic wave devices seem to have a promising future is the area of liquid conductivity measurement. The ability to measure a liquid's conductivity is important in a variety of applications and industries. For example, the automotive industry, it is important to detect and monitor the conductivity of oil in order to provide data related to the efficiency of the oil. In biological and medical applications, devices that monitor a liquid's conductivity are also extremely important. For example, electrolytic conductivity measurements can provide extensive uses in water purification, electroplating, and human blood or urea analysis.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved sensing device.

It is another aspect of the present invention to provide for an improved acoustic wave sensing device

It is yet another aspect of the present invention to provide for a wireless and passive acoustic wave sensor.

It is a further aspect of the present invention to provide for a liquid conductivity sensor.

The aforementioned aspects and other objectives and advantages can now be achieved as described herein. A method and system for measuring liquid conductivity utilizing an acoustic wave sensor is disclosed. In general, an acoustic wave device can be provided having a first interdigital transducer and a second interdigital transducer having a gap formed therein, wherein liquid comes into contact with the gap. For example, a liquid, such as oil, may flow through the gap. A measurement of the resistance of the gap can be performed in order to obtain data indicative of the conductivity of the liquid. The acoustic wave device can be configured, for example, as a bulk acoustic wave (BAW) device that generates at least one bulk acoustic wave that assists in providing a measurement of the conductivity of the liquid. The acoustic wave device may also be configured as a SH-SAW device that generates at least one shear-horizontal surface acoustic wave that assists in providing a measurement of the conductivity of the liquid. Alternatively, the acoustic wave device can be implemented as an FPW device that generates at least one flexural plate wave that assists in providing a measurement of the conductivity of the liquid. In still a further alternative, the acoustic wave device can be implemented as an SH-APM device that generates at least one shear horizontal surface acoustic wave that assists in providing a measurement of the conductivity of the liquid.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a perspective view of a flexural plate wave (FPW) device that can be adapted for use in accordance with one embodiment;

FIG. 2 illustrates a perspective view of an acoustic plate mode (APM) device that can be adapted for use in accordance with an alternative embodiment;

FIG. 3 illustrates top and cross sectional views of a shear horizontal surface acoustic wave (SH-SAW) device that can be adapted for use in accordance with another embodiment;

FIG. 4 illustrates a top view of a liquid conductivity sensor that can be implemented in accordance with a preferred embodiment; and

FIG. 5 illustrates a top view of a liquid conductivity sensor that can be implemented in accordance with a preferred, but alternative embodiment;

FIGS. 6(a) and 6(b) illustrate perspective views of a wireless and passive acoustic wave device that can be adapted for use in accordance with an alternative embodiment;

FIGS. 7(a) and 7(b) illustrate respective perspective and side views of a wireless and passive acoustic wave device that can be adapted for use in accordance with another embodiment; and

FIG. 8 illustrates a top view of a liquid sensor that can be implemented in accordance with a preferred, but alternative embodiment.

### DETAILED DESCRIPTION

The particular values and configurations discussed in these non-limiting examples can be varied and are cited merely to illustrate at least one embodiment and are not intended to limit the scope thereof.

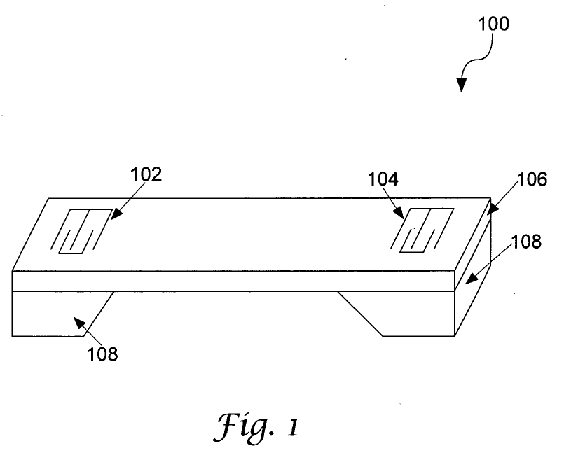

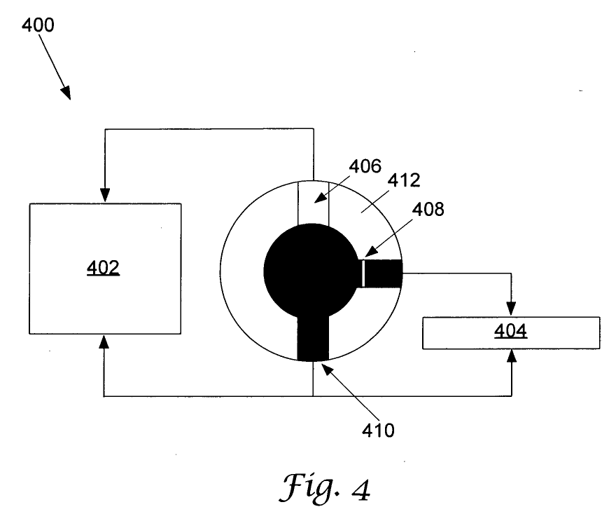

FIG. 1 illustrates a perspective view of a flexural plate wave (FPW) device 100 that can be adapted for use in accordance with one embodiment. FPW device 100 generally includes a silicon substrate 108 upon which a piezoelectric layer 106 is configured. An interdigital transducer (IDT) 102 and 104 can also be formed upon a piezoelectric substrate or layer 106. FPW device 100 can be implemented, for example, in the context of the liquid conductivity sensor depicted in FIG. 4. IDT 102, 104 can be configured in the form of electrodes, depending upon design considerations.

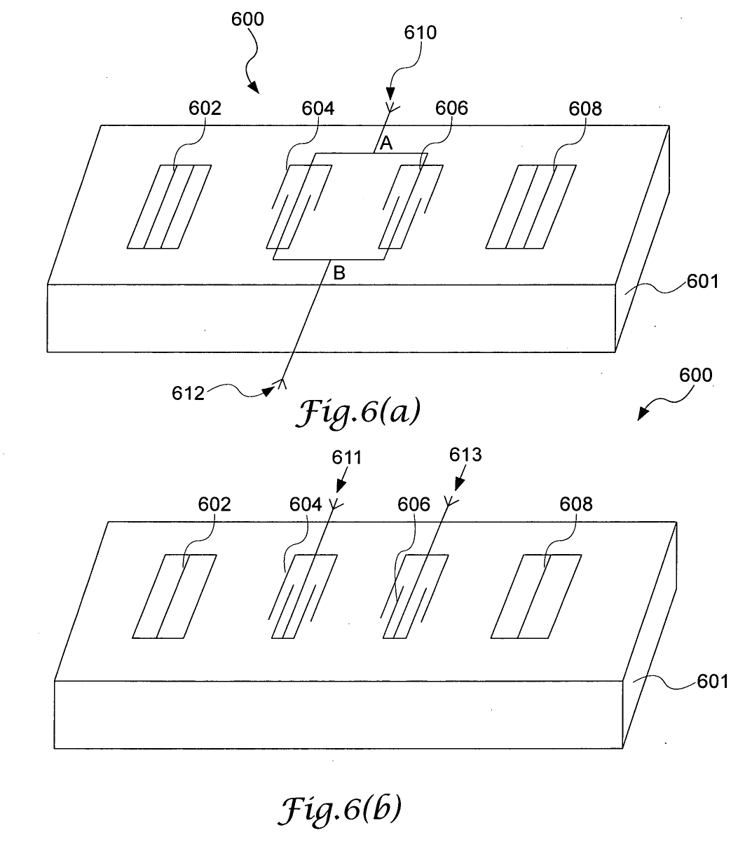

Piezoelectric substrate 106 can be formed from a variety of substrate materials, such as, for example, quartz, lithium niobate (LiNbO₃), lithium tantalite (LiTaO₃), Li₂B₄O₇, GaPO₄, langasite (La₃Ga₅SiO₁₄), ZnO, and/or epitaxially grown nitrides such as Al, Ga or Ln, to name a few. Interdigital transducers 102 and 104 can be formed from materials, which are generally divided into three groups. First, IDT 102, 104 can be formed from a metal group material (e.g., Al, Pt, Au, Rh, Ir Cu, Ti, W, Cr, or Ni). Second, IDT 102, 104 can be formed from alloys such as NiCr or CuAl. Third, IDT 102, 104 can be formed from metal-nonmetal compounds (e.g., ceramic electrodes based on TiN, CoSi₂, or WC). In general, a wireless and passive FPW device 100 can be implemented in the context of the liquid conductivity sensor 400 depicted in FIG. 6.

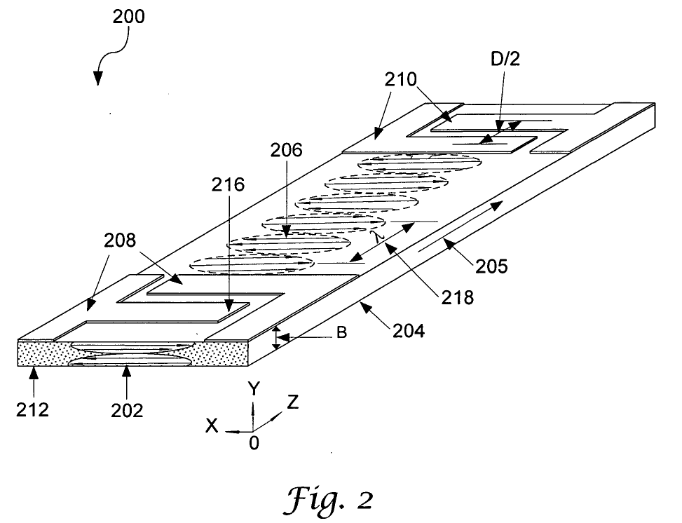

FIG. 2 illustrates a perspective view of an acoustic plate mode (APM) device 200 that can be adapted for use in accordance with an alternative embodiment. APM device 200 generally includes a substrate 204, which can be configured, for example, as a quartz plate. In the configuration depicted in FIG. 2, the APM device 200 is shown with the shear horizontal (SH) displacement of the mode as it propagates between input transducers 208 and output transducers 210. The mode propagation direction is generally indicated by arrow 205. Surface displacement 206 is also indicated in FIG. 2 in association with a wavelength 218. The y-direction 216 is also indicated in FIG. 2 along with the x-direction 212. The z-direction 214 is also indicated generally between O and Z in FIG. 2. A distance d/2 is also illustrated in addition to a length b, associated with the cross-sectional displacement 202. In general, a wireless and passive APM device 200 can be implemented in the context of the liquid conductivity sensor 400 depicted in FIG. 6.

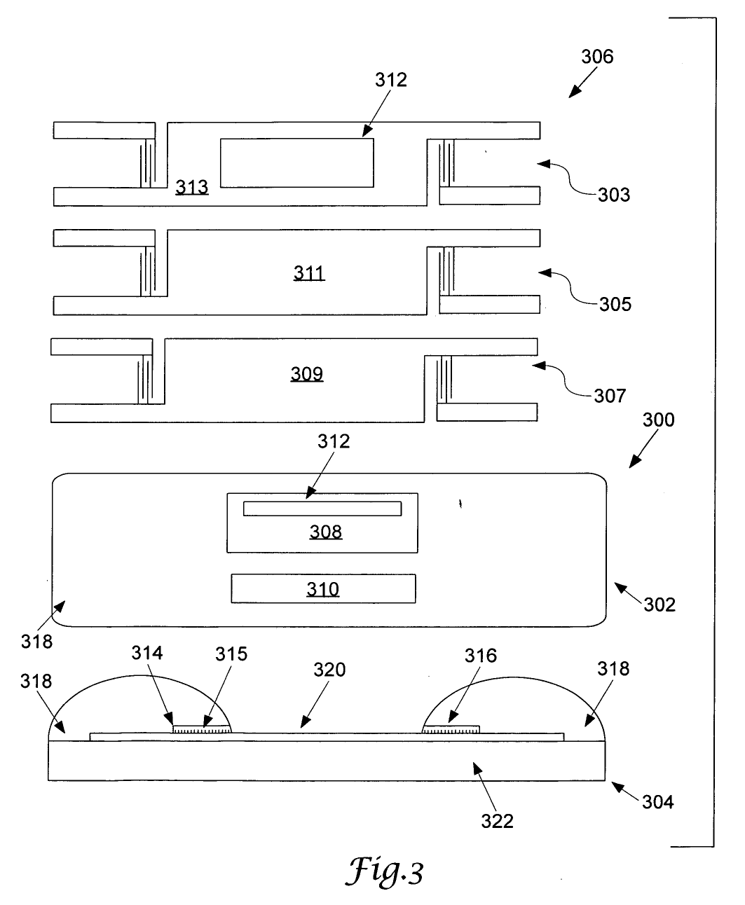

FIG. 3 illustrates top and cross sectional views of a shear horizontal surface acoustic wave (SH-SAW) device 300 that can be adapted for use in accordance with another embodiment. SH-SAW device 300 is shown with a top view 302 and a side view 304 in FIG. 3. Top view 302 of SH-SAW device 300 generally illustrates a free surface 312 in association with liquid cells 308 and 310. A silicon rubber area 318 is illustrated in both side view 304 and top view 302. Additionally, an interdigital transducer (IDT) 314, 316 is depicted in side view 304, along with an air gap 315 that is located between IDT 314 and silicon rubber area 318.

A piezoelectric layer 320 is also provided upon which IDTs 314 and 316 can be formed. SH-SAW device 300 can be implemented in the context of a multi-channel SH-SAW micro-sensor having an IDT pattern 306 including three 2-port SAW delay lines 303, 305, and 307. IDT pattern 306 can therefore be configured from a group of IDTS to comprise a pattern of two-port resonators that assist in providing a measurement of the conductivity of the liquid. Alternatively, an acoustic wave device can be configured as a two-port SH-SAW resonator device that generates at least one shear-horizontal surface acoustic wave that assists in providing a measurement of the conductivity of the liquid or a two-port FPW resonator device that generates one or more shear-horizontal surface acoustic waves that assist in providing a measurement of the conductivity of the liquid. In still a further variation, the acoustic wave device can be configured as a two-port APM resonator device that generates one or more shear-horizontal surface acoustic waves that assist in providing a measurement of the conductivity of the liquid, depending upon design considerations.

Pattern 306 includes the free surface 312 formed over a metalized surface 313. Delay line 305 is associated with a metalized surface 311, while delay line 307 is associated with a metalized surface 309. Note that the design principles of SH-SAW 2-port delay line device 300 are similar to those of a regular SAW device. For example, the configuration of IDTs 314, 316, along with the generation and detection of at least one shear horizontal surface acoustic wave is similar to that of SAW resonator or delay lines. Hence, the use of dual delay lines 303, 305, 307, and so forth can result in sensing and reference lines. The use of wave-guides can also be incorporated into SH-SAW device 300 to increase surface sensitivity. Wave-guiding can be accomplished, for example, by forming a suitable coating of appropriate thickness. Such a wave-guide layer can, incorporate, for example, the use of Love waves.

In general, the SAW and SH-SAW modes can be the same frequency range. Thus, the choice of different modes can be realized by adjusting certain parameters, such as, for example, the electrode thickness of the IDTs, electrode material selection (e.g., Al, Pt, Au, Rh, Ir Cu, Ti, W, Cr, or Ni), the aperture size of the IDTs, sets of IDT, wave-guide thickness, and the choice of different substrate materials or different cut angles. In general, a wireless and passive SH-SAW device 300 can be implemented in the context of the liquid conductivity sensor 400 depicted in FIG. 6. (added FIG. 6)

FIG. 4 illustrates a top view of a liquid conductivity sensor 400 that can be implemented in accordance with a preferred embodiment. Sensor 400 generally includes an acoustic wave device 401 composed of a bottom electrode 406 and a top electrode 410. Each electrode 406, 410 can be composed of an IDT formed upon a piezoelectric layer or substrate 412. A gap 408 can be formed from top electrode 410. Such a gap may be configured, for example, as a 30 um to 100 um gap for conductivity measurement. A resistance component 404 can be associated with acoustic wave device 401 in order to implement a resistance measurement for obtaining conductivity information.

Additionally, an external acoustic wave device 402 can be associated with the acoustic wave device 401, wherein the external acoustic wave device 402 is utilized, for example, as a wireless carrier. Acoustic wave device 402 can be, for example, a two-port surface acoustic wave (SAW) device. Acoustic wave device 401 can be implemented, for example, as flexural plate wave (FPW) device 100, acoustic plate mode (APM) device 200, or shear horizontal surface acoustic wave (SH-SAW) device 300, depending upon design considerations.

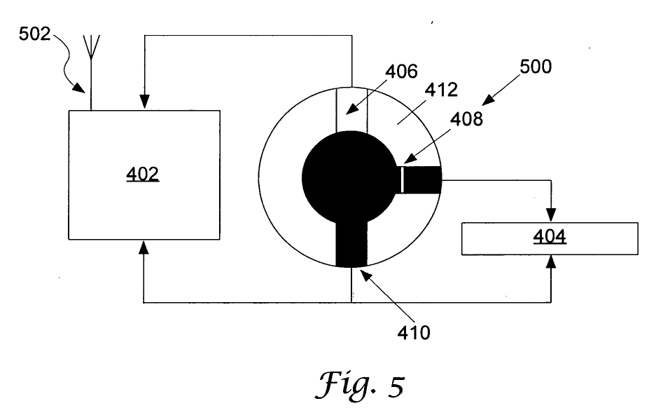

FIG. 5 illustrates a top view of a liquid conductivity sensor 500 that can be implemented in accordance with a preferred, but alternative embodiment. Note that in FIGS. 4-5, identical or similar parts or elements are indicated by identical reference numerals. Thus, sensor 500 of FIG. 5 is similar to sensor 400 depicted in FIG. 4, the difference being that sensor 500 incorporates the use of an antenna 502 for the wireless transmission of data.

FIGS. 6(a) and 6(b) illustrate perspective views of a wireless and passive acoustic wave device 600 that can be adapted for use in accordance with an alternative embodiment. Note that in FIGS. 6(a) and 6(b), identical or similar parts or elements are generally indicated by identical reference numerals. Acoustic wave device 600 generally includes a group of interdigital transducers (604 and 606) and reflectors (602 and 608) which can be configured upon a piezoelectric substrate or layer 601. In FIG. 6(a), antennas 610 and 612 are illustrated, while in FIG. 6(b), antennas 611 and 613 are indicated. In the configuration of FIG. 6(a), interdigital transducer 604 can be connected electrically to interdigital transducer 606 at node A. Antenna 610 is connected to node A. Similarly, Antennas 610 and 612 can be electrically connected to one another at node B. Antenna 612 is generally connected to node B. In the configuration depicted in FIG. 6(b), antenna 611 is directly connected to IDT 604, while antenna 613 is directly connected to IDT 606. The wireless and passive acoustic wave device 600 can be implemented, for example, in the context of the liquid conductivity sensor 300 depicted in FIG. 3. IDTs 604 and 606 are generally configured in the form of electrodes, depending upon design considerations. Note that antennas 610, 611, 612, and/or 613 can be implemented, for example, in the context of antenna 502 depicted in FIG. 5.

In general, acoustic wave device 600 can be associated with a sensing mechanism that is connectable to a liquid, wherein the sensing mechanism comprises one or more acoustic wave sensing elements such as, for example, IDTs 604 and 606, and one or more antennas such as, for example, antennas 610, 612 or 611, 613 that communicate with IDTs 604 and 606. One or more of the IDTs 604 and 606 can be in contact with a liquid, such that the IDT associated with the liquid in response to an excitation of the at least one acoustic wave sensing element, thereby generates data indicative of the conductivity of the liquid for wireless transmission through one or more of antennas 610, 612 or 611, 613.

The excitation of one or more of the acoustic wave sensing elements (e.g., IDTs 604, 606) occurs in response to at least one wireless signal transmitted to one or more of antennas 610, 612 or 611, 613. The liquid can be, for example, oil, and the acoustic waves associated with the liquid or oil can comprise one or more of the following types of acoustic waves: bulk wave, acoustic plate mode, shear-horizontal acoustic plate mode, surface transverse wave, flexural plate wave and shear-horizontal surface acoustic waves.

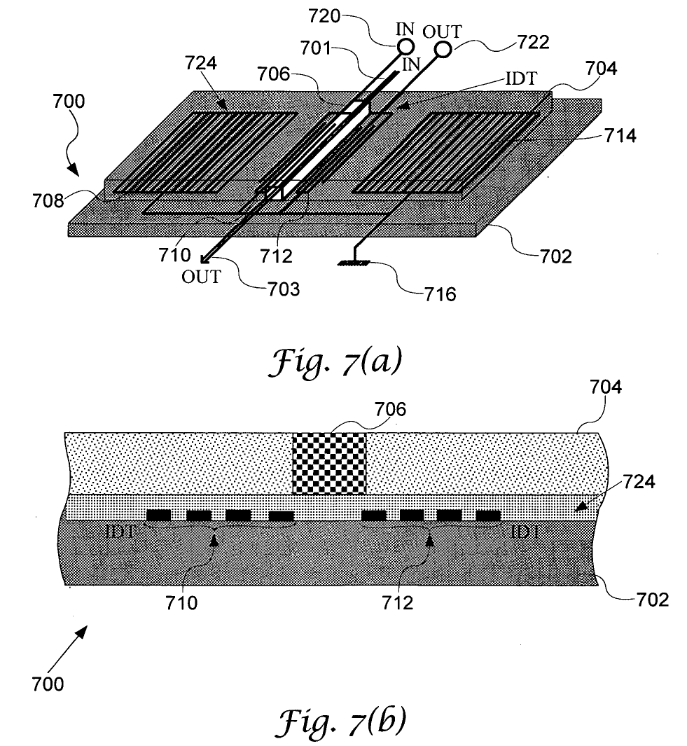

FIGS. 7(a) and 7(b) illustrate respective perspective and side views of a wireless and passive acoustic wave device 700 that can be adapted for use in accordance with another embodiment. Device 700 can be adapted, for example, for use with the liquid conductivity sensor 500 depicted in FIG. 5. The wireless and passive acoustic wave device 700 illustrated in FIGS. 7(a) and 7(b) is similar to the wireless and passive acoustic wave device 600 depicted in FIG. 6, except that varying features are provided. For example, wireless and passive acoustic wave device 700 generally includes a piezoelectric substrate 702 upon which one or more IDTs (710 and 712) and reflectors (708 and 714) can be configured. A gap or cavity 706 can also be provided within which liquid can flow as indicated by arrows 701 and 703, respectively “In” and “out” liquid flow arrows. A reflector 708 and 714 can also be configured upon substrate 702 in association with IDTs 710 and 712. Respective input and output electrical connections or nodes 720, 722 can also be provided. IDT 714 can be connected to an antenna 716 in a wired design. In a wireless design, the antenna(s) will be connected to IDT 710 or 712, which is generally analogous to antennas 610, 611, 612, and/or 613 depicted in FIG. 6 or, for example, antenna 502 depicted in FIG. 5.

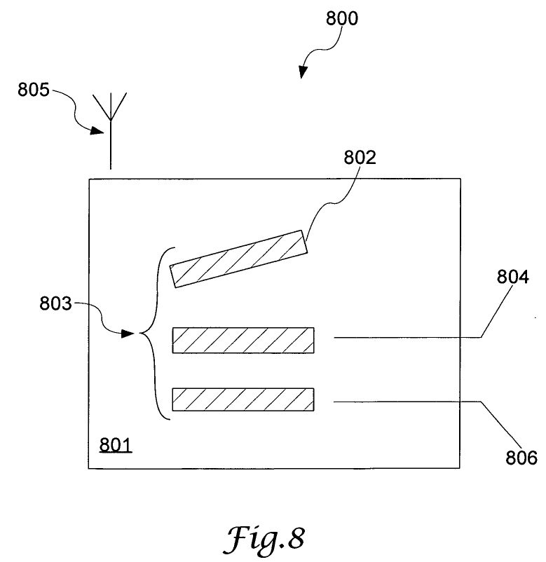

FIG. 8 illustrates a top view of a liquid sensor 800 that can be implemented in accordance with a preferred, but alternative embodiment. Note that in FIG. 8, three sensing elements 802, 804, 806 are located on the same sensor substrate 801. The first sensing element 801 is not parallel to the other two sensing elements 804 and 806. Therefore, the 802 will have a different temperature coefficient of frequency curve than 804 and 806. By measuring frequency differences of the three sensing elements 802, 804, 806, temperature and other parameters, such as conductivity, can be obtained. In the configuration of FIG. 8, substrate 801 can be implemented similar to that of substrate or layer 106 depicted in FIG. 1 or, for example, substrate 601 depicted in FIGS. 6(a) and 6(b). Similarly, sensing elements 802, 804, 806 can be implemented as interdigital transducers such as, for example, IDTs 602, 604, 606, 608, and so forth. Thus, the configuration depicted in FIG. 8 can be utilized to implement a liquid conductivity sensor.

Sensor 800 therefore comprises a wireless and passive liquid sensing sensor. A sensing mechanism 803 of the acoustic wave device or sensor 800 is connectable or can contact a liquid. The sensing mechanism 803 constitutes the three acoustic wave sensing elements 802, 804 806 and one or more antennas 805 associated with said acoustic wave device 800 that communicates with the three acoustic wave sensing elements 802, 804, 806. In general, at least one of the sensing elements 802 is configured offset (i.e., not parallel) to the other two sensing elements 804, 806, thereby creating different temperature coefficients of frequency among the three sensing elements 802, 804, 806, thereby allowing said acoustic wave device 800 to obtain data indicative of temperature and other parameters associated with said liquid. Such other parameters can include, for example, viscosity, conductivity, pH, lubricity, and corrosivity.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for measuring liquid conductivity utilizing an acoustic wave sensor, comprising:
providing an acoustic wave device having a first interdigital transducer and a second interdigital transducer having a gap formed therein, wherein a liquid contacts said gap; and
measuring a resistance of said gap in order to obtain data indicative of a conductivity of said liquid.

2. The method of claim 1 wherein said acoustic wave device comprises a bulk acoustic wave (BAW) device that generates at least one bulk acoustic wave that assists in providing a measurement of said conductivity of said liquid.

3. The method of claim 1 wherein said acoustic wave device comprises an SH-SAW device that generates at least one shear-horizontal surface acoustic wave that assists in providing a measurement of said conductivity of said liquid.

4. The method of claim 1 wherein said acoustic wave device comprises an FPW device that generates at least one flexural plate wave that assists in providing a measurement of said conductivity of said liquid.

5. The method of claim 1 wherein said acoustic wave device comprises an SH-APM device that generates at least one shear horizontal surface acoustic wave that assists in providing a measurement of said conductivity of said liquid.

6. The method of claim 1 further comprising forming said first and second interdigital transducers to comprise a pattern of dual delay lines that assist in providing a measurement of said conductivity of said liquid.

7. A method for measuring liquid conductivity utilizing an acoustic wave sensor, comprising:
providing an acoustic wave device having a plurality of interdigital transducers formed thereon, wherein a cavity is configured from said acoustic wave device, wherein a liquid is flowable through the said cavity; and
measuring a frequency change of said acoustic wave device in order to obtain data indicative of a conductivity of said liquid flowing through said cavity.

8. The method of claim 7 wherein said acoustic wave device comprises an SH-SAW device that generates at least one shear-horizontal surface acoustic wave that assists in providing a measurement of said conductivity of said liquid.

9. The method of claim 7 wherein said acoustic wave device comprises an FPW device that generates at least one flexural plate wave that assists in providing a measurement of said conductivity of said liquid.

10. The method of claim 7 wherein said acoustic wave device comprises an APM device that generates at least one shear horizontal surface acoustic wave that assists in providing a measurement of said conductivity of said liquid.

11. The method of claim 7 further comprising forming said plurality of interdigital transducers comprise a pattern of dual delay lines that assist in providing a measurement of said conductivity of said liquid.

12. The method of claim 7 further comprising configuring said plurality of interdigital transducers to comprise a pattern of two-port resonators that assist in providing a measurement of said conductivity of said liquid.

13. The method of claim 7 wherein said acoustic wave device comprises a two-port SH-SAW resonator device that generates at least one shear-horizontal surface acoustic wave that assists in providing a measurement of said conductivity of said liquid.

14. The method of claim 7 wherein said acoustic wave device comprises a two-port FPW resonator device that generates at least one shear-horizontal surface acoustic wave that assists in providing a measurement of said conductivity of said liquid.

15. The method of claim 7 wherein said acoustic wave device comprises a two-port APM resonator device that generates at least one shear-horizontal surface acoustic wave that assists in providing a measurement of said conductivity of said liquid.

16. A wireless and passive liquid conductivity sensing system, comprising:
an acoustic wave device; and
a sensing mechanism that is connectable to said liquid, wherein said sensing mechanism comprises at least one acoustic wave sensing element formed from said acoustic wave device and at least one antenna associated with said acoustic wave device that communicates with said at least one acoustic wave sensing element, wherein when said at least one acoustic wave sensing element is in contact with said liquid, such that said at least one acoustic wave sensing element detects acoustic waves associated with said liquid in response to an excitation of said at least one acoustic wave sensing element, thereby generating data indicative of a conductivity of said liquid for wireless transmission through said at least one antenna.

17. The system of claim 16 wherein said excitation of said at least one acoustic wave sensing element occurs in response to at least one wireless signal transmitted to said at least one antenna.

18. The system of claim 17 wherein said acoustic waves associated with said liquid comprise at least one of the following types of acoustic waves: bulk wave, acoustic plate mode, shear-horizontal acoustic plate mode, surface transverse wave, flexural plate wave and shear-horizontal surface acoustic waves.

19. The system of claim 17 wherein said at least one acoustic wave sensing element comprises a plurality of interdigital transducers configured in a pattern of dual delay lines that assist in providing a measurement of said conductivity of said liquid.

20. The system of claim 17 wherein said at least one acoustic wave sensing element comprises a plurality of interdigital transducers configured in a pattern of two-port resonators that assist in providing a measurement of said conductivity of said liquid.

21. The system of claim 17 wherein said acoustic wave device comprises at least one of the following types of acoustic wave devices:
a two-port SH-SAW resonator device that generates at least one shear-horizontal surface acoustic wave that assists in providing a measurement of said conductivity of said liquid;
a two-port FPW resonator device that generates at least one shear-horizontal surface acoustic wave that assists in providing a measurement of said conductivity of said liquid; or
a two-port APM resonator device that generates at least one shear-horizontal surface acoustic wave that assists in providing a measurement of said conductivity of said liquid.

22. A wireless and passive liquid sensing system, comprising:
an acoustic wave device; and
a sensing mechanism that is connectable to a liquid, wherein said sensing mechanism comprises at least three acoustic wave sensing elements formed from said acoustic wave device and at least one antenna associated with said acoustic wave device that communicates with said at least three acoustic wave sensing element, wherein at least one sensing element of the said at least three acoustic wave sensing elements is configured offset from theat least two acoustic wave sensing elements among said at least three acoustic wave sensing elements, thereby creating different temperature coefficients of frequency among said at least three sensing elements, thereby allowing said acoustic wave device to obtain data indicative of temperature and other parameters associated with said liquid.

23. The sensor system of claim 22 wherein said other parameters include viscosity, conductivity, pH, lubricity, and corrosivity.
